(19) United States
(12) Patent Application Publication
(10) Pub. No.: US 2015/0013163 A1
(43) Pub. Date: Jan. 15, 2015

(54) INSULATED WALL PANEL APPARATUSES, SYSTEMS, AND METHODS

(71) Applicant: Clark M. Martens, East Aurora, NY (US)

(72) Inventor: Clark M. Martens, East Aurora, NY (US)

(21) Appl. No.: 14/332,730

(22) Filed: Jul. 16, 2014

Related U.S. Application Data
(63) Continuation-in-part of application No. 13/903,157, filed on May 28, 2013, now abandoned.
Application No. 13/903,157 is a continuation-in-part of application No. 13/113,010, filed on May 20, 2011, now abandoned.

(51) Int. Cl. E04C 2/284; B25C 1/04; B25C 1/06; B25C 1/00

(52) U.S. Cl. CPC E04C 2/284; B25C 1/00; B25C 1/04; B25C 1/06
USPC 29/897.32; 173/90

(57) ABSTRACT

Methods, systems, and apparatuses for providing insulation for a wall panel, an embodiment of an insulated wall panel including a weather barrier, an insulating layer abutting the weather barrier, a moisture barrier abutting the insulating layer, and structural layer abutting the moisture barrier, and possibly a second insulating layer abutting the structural layer. The insulated wall panel may also include a plurality of nails, each nail having a head embedded in the insulating wall panel abutting the structural layer. A nail gun including a barrel with a toothed end or an end with an adjacent having a flat outer side may propel the nail into the insulating wall panel.

### CROSS-REFERENCE TO RELATED APPLICATIONS

This application is a continuation-in-part of U.S. Non Provisional patent application Ser. No. 13/903,157 filed on May 28, 2013 that is a continuation-in-part of U.S. Non Provisional patent application Ser. No. 13/113,010, filed May 20, 2011.

### FIELD OF THE INVENTION

This invention is related to building construction, and more particularly to the construction of wall panel insulation.

### BACKGROUND OF THE INVENTION

Current editions of the International Residential Code (IRC) call for exterior walls built in almost all of the United States to have insulation of R20 or R13+5. In order to use the R-20 insulation, a 2×6 exterior wall has to be framed to fit insulation in the wall cavity. A lower cost alternative is to use the R-13+5 method. The R-13+5 method can use ordinary fiberglass batts within a 2×4 exterior wall and then have the outside of the wall wrapped in an R-5 rated insulated sheathing.

Polystyrene has been recognized to meet the R-5 rating and to be a suitable product to use as an exterior insulation. It can be difficult to affix the sheets to exterior structural sheathing that is already affixed to the framed wall due to the low density of polystyrene and the large size of the sheets. The sheets of polystyrene can act as a sail and it can take a great deal of time to affix the polystyrene sheets to sheathing that is already attached to the wall studs. One solution has been to pre-attach extruded polystyrene (XPS) or polysocyanurate to the structural sheathing and then affix the XPS or polysocyanurate insulated sheathing to the studs.

XPS has the benefit of being waterproof due to its closed cell construction. However, XPS has the disadvantage of being more expensive than alternatives such as expanded polystyrene (EPS). Additionally, the use of XPS can create difficulties in attaching structural sheathing to the wall frame because nails and other fasteners do not readily pass through XPS to form a tight fit against the structural sheathing. XPS is a denser and less brittle material than a material such as EPS, requiring greater force to pass fasteners such as nails and screws through XPS. But when attaching sheathing to the studs, sitting the fastener heads adjacent to the structural sheathing provides a strong mechanical connection to the studs. Such a connection will increase the durability of the connection between the structural sheathing and the studs and the durability of the wall, which depends on the sheathing for structural support.

Although EPS, for example, may be a low cost alternative to XPS for insulation purposes, EPS is not waterproof, allowing water to migrate through its open cell structure. As a result, EPS by itself will not waterproof the structural sheathing and a secondary waterproof material may be needed to ensure a watertight exterior wall.

Based on the problems described above, what is needed in the industry is an insulated wall panel in which R-5 insulation is pre-attached to the sheathing. The insulated structural sheathing may need to be waterproof and may be more durable if their fasteners such as nails or screws can have their heads seated adjacent to the structural sheathing, making the wall more durable. The invention described below provides these needed qualities in a low cost system.

Another problem with the prior wall construction is in the manner that the boards are secured to the wall studs. For example, in one past embodiment there is a layer of oriented strand board (hereafter referred to as OSB), wall studs, and a layer of foam such that the foam layer is disposed between the OSB and wall studs. A nail is driven through the OSB and foam and into the stud such that the nail head abuts the OSB. The problem with this structural arrangement is that the shear capacity is decreased. In another example, there are wall studs and the OSB abuts the wall studs, but the fasteners used to secure the layer of foam to the OSB are not physically seated on the studs. Both of these methods result in walls that are not sturdy because they are incapable of resisting shearing forces or loads, and this allows the undesirable wall movement.

Thus, there is a need for an improved wall and method of making same that overcomes the problems outlined above.

### SUMMARY OF THE INVENTION

In an embodiment, an insulated wall panel includes a weather barrier, an insulating layer abutting the weather barrier, a moisture barrier abutting the insulating layer, and a structural layer abutting the moisture barrier, the moisture barrier between the insulating layer and the structural layer.

In another embodiment, an insulated wall panel includes: an insulating layer; a moisture barrier abutting the insulating layer; a structural layer abutting the moisture barrier; a plurality of studs abutting the structural layer; a plurality of insulating panels abutting the structural layer, each of the plurality of insulating panels positioned between two of the plurality of studs; and a plurality of fasteners, each of the plurality of fasteners including a head, each head embedded in the insulated wall panel such that the head is abutting the structural layer.

In another preferred embodiment there is a nail gun that is designed with a plate and barrel wherein the barrel is flush with and terminates at the plate. The nail gun has an elongated pin (sometimes the word pin is referred to herein as blade) such that it is capable of driving the head of a fastener through a layer of insulation and all the way to a structural member. In another preferred embodiment there is a nail gun that has a barrel and a truncated drive pin is positioned in the barrel. There is a fastener that has a head and a second head, that is, it is a double-headed fastener. The distance from the head to the second head is one inch in one of the preferred embodiments. After expelled from the nail gun, the head of a fastener is driven through a layer of insulation and all the way to a structural member. After installation, the second head is visible and this allows for the easy visual inspection of the wall.

Other embodiments, which may include one or more parts of the aforementioned method or systems or other parts, are also contemplated, and may thus have a broader or different scope than the aforementioned method and systems. Thus, the embodiments in this Summary of the Invention are mere examples, and are not intended to limit or define the scope of the invention or claims.

### BRIEF DESCRIPTION OF THE DRAWINGS

The accompanying drawings, wherein like reference numerals are employed to designate like components, are included to provide a further understanding of insulated wall panel apparatuses, systems, and methods, are incorporated in and constitute a part of this specification, and illustrate embodiments of insulated wall panel apparatuses, systems, and methods that together with the description serve to explain the principles of insulated wall panel apparatuses, systems and methods.

Various other objects, features and advantages of the invention will be readily apparent according to the following description exemplified by the drawings, which are shown by way of example only, wherein:

FIG. 1 illustrates a perspective view of an embodiment of an insulated wall panel;

FIG. 2 illustrates a top view of an embodiment of an insulated wall panel;

FIG. 3 illustrates a side view of an embodiment of an insulated wall panel;

FIG. 4 illustrates a partial top view of an insulated wall panel along with a nail gun;

FIG. 5 illustrates a partial top view of an insulated wall panel along with another embodiment of a nail gun;

FIG. 6 illustrates a partial side view of an embodiment of an insulated wall panel to floor structure interconnection;

FIG. 7 illustrates a partial top view of an insulated wall panel along with another embodiment of a nail gun; and,

FIG. 8 illustrates a partial top view of an insulated wall panel along with another embodiment of a nail gun.

### DETAILED DESCRIPTION

Reference will now be made to embodiments of insulated wall panel apparatuses, systems, and methods, examples of which are illustrated in the accompanying drawings. Details, features, and advantages of the insulated wall panel apparatuses, systems, and methods will become further apparent in the following detailed description of embodiments thereof.

As used herein, an “insulated wall panel” refers to an insulated panel used to construct a building. An insulated wall panel may comprise a portion or all of a residential or commercial building wall installed mostly or completely above grade. The insulated wall panel may include one or more components described herein with respect to an insulated wall panel, such as, for example, support elements, elements that secure or facilitate the securing of portions of the insulated wall panel to other panels or other structures, and/or elements that accommodate the inclusion of elements of a structure, such as, for example, doors, windows, driveways, brick and other facades, supports such as support beams, the extension of wiring or pipes through the insulated wall panel, and/or other elements.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification do not necessarily all refer to the same embodiment. References to “or” are furthermore intended as inclusive, so “or” may indicate one or another of the ored terms or more than one ored term.

As used herein, the term “abutting” means contacting and touching and directly next to without any intervening structure. That is, when two layers are recited as abutting each other, those two layers are contacting each other, are touching each other, are directly next to each other.

It is pointed out that the same reference numerals used in the description and shown in the drawing figures designate common parts, elements and components.

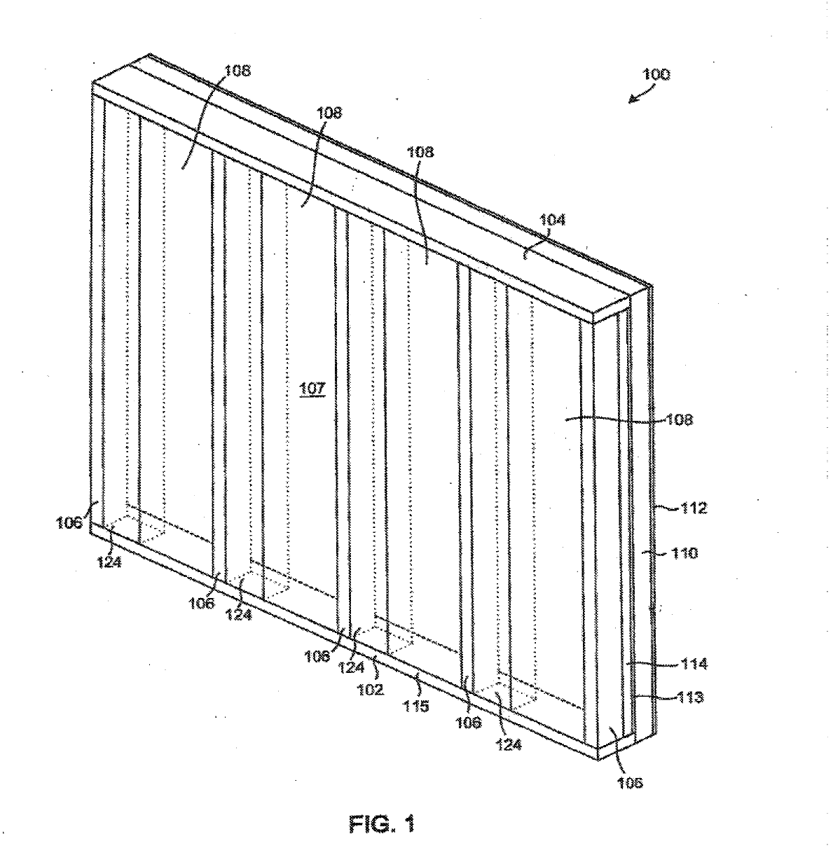

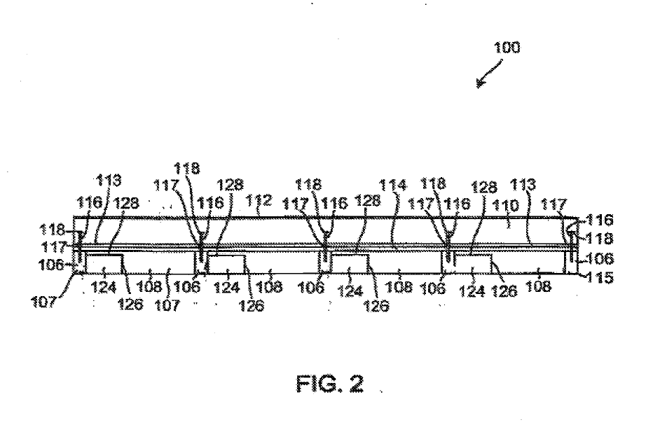

FIGS. 1-3 illustrates a perspective view of an insulated wall panel 100. In various embodiments, the insulated wall panel 100 may include one or more of a base plate 102, a header plate 104, one or more studs 106, an insulating layer 110, a second insulating layer 107 (which may include a plurality of insulating panels 108), a weather barrier 112, a moisture barrier 113, and a structural layer 114. For example, FIG. 2, discussed below, illustrates the insulated wall panel 100 of FIG. 1 but without the header plate 104 attached thereto.

In another example, in an embodiment as shown in FIGS. 1-3, the insulated wall panel 100 includes an exterior weather barrier 112, an insulating layer 110 abutting the weather barrier 112, a moisture barrier 113 abutting the insulating layer 110, and the structural layer 114 abutting the moisture barrier 113. The moisture barrier 113 is thus between the insulating layer 110 and the structural layer 114 in this embodiment. The insulated wall panel 100 may also include at least one stud 106 abutting the structural layer 114.

In an embodiment, the insulated wall panel 100 further includes a second insulating layer 107 abutting the structural layer 114. The second insulating layer 107 may include a plurality of insulation panels 108, such as four or another number, each abutting the structural layer 114. At least one of the studs 106 may extend between two of the insulation panels 108. For example, in one embodiment as shown in FIG. 2, the central stud 106 extends between insulation panels 108 on either side. Additionally, from that view, the two studs 106 to the immediate left and right of the central stud 106 also extend between two insulation panels 108. Likewise, each of the insulating panels 108 may be positioned between two of the studs 106.

The base plate 102, header plate 104, and plurality of studs 106 may together refer to the framing 115 of the insulated wall panel 100. If the insulated wall panel 100 does not include either or both a base plate 102 and header plate 104, the framing 115 will correspondingly exclude either or both the base plate 102 and header plate 104. If another part or parts are substituted for the base plate 102 and/or header plate 104, the framing will include the part or parts. If an additional part or parts is included, the framing 115 will include that part or parts. For example, in certain embodiments (not shown), the framing 115 may include a stud, bracing, or another member or members configured and positioned to support a door, window, or beam pocket, or any other structure to be included in the insulated wall panel 100. The insulated wall panel 100 may thus include openings, such as described below, to accommodate one or more of the aforementioned structures.

The base plate 102 may be of any desired material suitable for building construction, including wood, steel, or concrete. The base plate 102 may furthermore be set on or attached to a footer, foundation wall, or other structure.

The header plate 104 may also be of any desired material suitable for building construction, including wood, steel, or concrete. The header plate 104 may furthermore support another structure such as, for example, another wall or a roof structure.

The studs 106 may be of any desired material suitable for construction, including wood, steel, or concrete. The studs 106, base plate 102 and header plate 104 may furthermore be formed in any desired size, such as a nominal 2×4 or 2×6 dimension, and in any desired length. Alternately, any other structural support member or members may be used in place of the studs 106. The studs 106 or other structural support member or members may furthermore provide one or more of an axial, shear, and lateral load bearing aspect to the insulated wall panel 100.

In traditional walls, studs create an undesirable thermal break since insulation is placed between the studs 106. In certain embodiments of the present insulated wall panel 100, the insulating layer 110 may be continuously unbroken by studs 106 or other support members to create a thermal break between the studs 106 or other components of the framing 115 and the exterior of the building to increase insulation in the insulated wall panel 100, though in other embodiments the insulating layer 110 may be broken. In embodiments, the insulating layer 110 provides structural support, and the weather barrier 112 and moisture barrier 113 may be attached to opposite sides of the insulating layer 110 by adhesives or otherwise. In one embodiment, the moisture barrier 113 may itself be an adhesive, and may comprise polyurethane. In this embodiment, the moisture barrier 113 may be between, and attach, the insulating layer 110 and the structural layer 114.

The weather barrier 112, if included, may be or include a polypropylene film or another waterproof film or other waterproof layer. The weather barrier 112 can also comprise a film of polyester, polyethylene, solid foil, paper laminated foil, asphalt felt, coated glass scrim, coated paper and combinations thereof. The weather barrier 112 can also be embodied as a vapor impermeable film. The weather barrier 112 may also be attached to the insulating layer 110 opposite the moisture barrier 113 by glue or as desired.

The insulating layer 110 and second insulating layer 107 (which may include insulating panels 108) may be formed of any insulating materials including, for example, fire retardant polystyrene foam or another foam material. In an embodiment, the insulating layer 110 and/or second insulating layer 107 (e.g., insulating panels 108) is formed of expanded polystyrene (EPS), such as EPS having at least an R-5 total value. In another embodiment, the second insulating layer 107 comprises fiberglass batt, such as fiberglass batt having at least an R-13 total value. The insulating layer 110 and second insulating layer 107 may furthermore be formed in any desired thicknesses, such as eight inch or ten inch thicknesses. The thicknesses may furthermore be determined based on the location of the building in which the insulated wall panel 100 is included such that a building constructed in a cold climate may be constructed with a thicker insulating layer 110 and/or second insulating layer 107.

The moisture barrier 113 may be or include polyurethane or another waterproof layer or waterproof film. As described above, the moisture barrier 113 may be between the insulating layer 110 and the structural layer 114. As so positioned, the moisture barrier 113 may prevent most or all moisture that may penetrate the weather barrier 112 (such as through holes or rips that may form therein over time) and insulating layer 110 (such as if not waterproof) from penetrating the structural layer 114. The moisture barrier 113 may thus, along with the weather barrier 112 if included, prevent moisture from penetrating the entire insulating wall panel 100 and entering the interior of the building.

The structural layer 114 may be plywood, pressed wood board such as oriented strand board (OSB), or any type of structural layer desired. The structural layer 114 may be attached to the insulating layer 110 by glue, such as a polyurethane adhesive or a construction adhesive, or otherwise as desired.

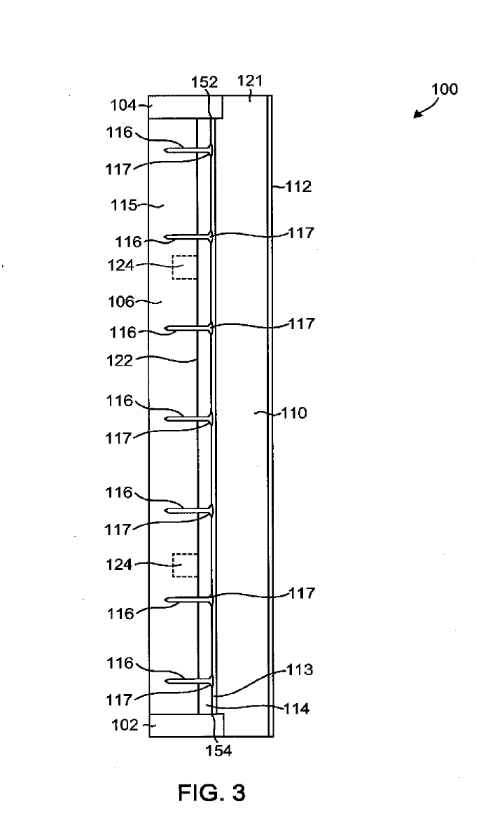

As shown in the embodiment of FIG. 3, the insulated wall panel 100 may include a header recess 152 in which the header plate 104 may be disposed and a base plate recess 154 in which the base plate 102 may be disposed. Studs 106 may be fastened to the base plate 102 or header plate 104 prior to or after placement of other parts of the insulating wall panel 100 such as the second insulating layer 107, structural layer 114, moisture barrier 113, insulating layer 110, and weather barrier 112.

Referring again to FIG. 2, one or more removable chase portions 124 may be formed in the insulating panels 108 of the second insulating layer 107. In an embodiment, removable chase portions 124 of the insulating panels 108 are formed so they may be simply removed to create a chase (not shown) in the insulated wall panel 100. For example, a parallel cut 126 may be placed in a vertical line parallel to the studs 106 through an insulating panel 108. The removable chase portion 124 of the insulating panel 108 may thus be grasped and pulled from the remainder of the insulating panel 108 along the parallel cut 126 to expose a chase where the removable chase portion 124 of the insulating panel 108 was removed.

In another embodiment, a perpendicular cut 128 may be placed perpendicular to a stud 106 to adjust the depth of the chase portion 124. A parallel cut 126 may also be placed in a vertical line through the removable chase portion 124 of the insulating panel 108 so that the removable chase portion 124 of the insulating panel 108 may be grasped and pulled from the remainder of the insulating panel 108 along the vertical line to expose a chase.

It should be recognized that one or more parallel cuts 126 may be used to form each removable chase portion 124. In an embodiment, a single parallel cut 126 is created adjacent to a stud 106 to form a chase adjacent to the stud 106. The parallel cut or cuts 126 may furthermore be positioned to create a chase of a desired width, such as the width of a standard wall outlet box. Similarly, the perpendicular cut 128 may be positioned at any desired depth to create a chase of a desired depth and maximize the thickness of the insulating panel 108 to maximize the insulating property of the insulated wall panel 100.

It should also be recognized that the parallel cut 126 or the perpendicular cut 128 may be continuous, thus relying on friction to retain the removable chase portion 124 in the insulating panel 108 until removal. Alternatively, the parallel cut 126 or the perpendicular cut 128 may include a series of linear cuts separated by uncut portions. The uncut portions of the removable chase portion 124 may then be cut or torn to remove the removable chase portion 124.

Such a construction, in which studs 106, chases, and the like are built into the insulating layers 107 and 110 of the insulated wall panel 100, may also permit the insulated wall panel 100 to be thinner than previous insulated wall panels.

Referring again to FIG. 3, one or more removable chase portions 124 may be positioned horizontally in the insulating panels 108 of the insulating layer 107. Such horizontal removable chase portions 124 may be removed from the insulating panels 108 to provide a hole in the wall for any desired purpose including, for example, the insertion of piping or wire.

Fasteners 116, such as screws, nails, and/or other fasteners, may be included in the insulated wall panel 100. In an embodiment, the fasteners may each be positioned through the insulating layer 110, moisture barrier 113, and structural layer 114 and into a stud 106, the header plate 104, or the base plate 102. The fasteners may be placed after the weather barrier 112 is attached, and thus pass through the weather barrier 112 as well.

In an embodiment such as shown in FIGS. 2-3, the insulated wall panel 100 includes one or more fasteners 116. Each fastener 116 may include a head 117. Each fastener 116 may be positioned within the insulated wall panel 100 such that the head 117 is embedded in the insulated wall panel 100, as opposed to the head 117 being positioned adjacent the exterior of the insulated wall panel 100 such as adjacent the weather barrier 112. In one embodiment, the head 117 of each fastener 116 is embedded in the insulated wall panel 100 such that it is abutting the structural layer 114, for example. As so embedded, the fastener 116 may extend through the structural layer 114 and into the stud 106. Seating the head 117 against the structural layer 114 may provide durability to the insulated wall panel 100 and may also prevent moisture from passing through the structural layer 114 abutting the fastener 116.

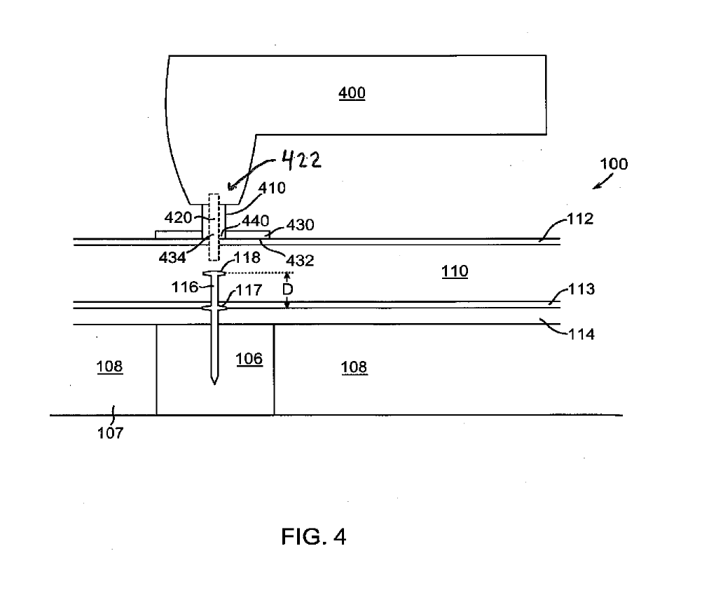

In another embodiment, one or more of the fasteners 116 include second heads 118 along with the heads 117, such as shown in FIGS. 2 and 4 (instead of just the heads 117, such as shown in the embodiments of FIGS. 3, 5, and 6). In this embodiment of the fasteners 116, for each of those fasteners 116, the second head 118 may be embedded in the insulated wall panel 100, such as in the insulating layer 110, for example. The head 117 may be abutting the structural layer 114. In an embodiment in which one or more of the fasteners 116 includes the two heads, heads 117 and 118, the distance D between the heads, as shown in FIG. 4 (which is discussed below), is greater than 3/16 inch, though that dimension may be different in other embodiments.

In an embodiment in which each fastener 116 is a nail, in order to drive each fastener 116 (whether with one head 117 or two heads 117 and 118) into the insulation wall panel 100 such that the head 117 is abutting the structural layer 114, a nail gun may be used. FIG. 4 illustrates a partial top view of the insulated wall panel 100 along with an embodiment of a nail gun 400. The nail gun 400 may be powered as desired, such as by electromagnetic power, pneumatic pressure, or internal combustion. The nail gun 400 may include a barrel 410 and drive pin 420, and the drive pin 420 is driven by a drive assembly 422 that is powered by, for example, electromagnetic power, pneumatic pressure, or internal combustion. The drive assembly 422 extends and retracts the drive pin 420. It is to be understood that drive assemblies for extending and retracting the drive pins in nail guns are well known to those having ordinary skill in the art and are therefore not described herein in greater detail.

In one embodiment, the nail gun 400 also includes a plate 430 positioned abutting the end 440 of the barrel 410. The plate 430 may be a separate piece or may be integral with the barrel 410. The plate 430 may have a flat outer side 432 that may be positioned against the insulated wall panel 100, such as against the weather barrier 112 or, if the weather barrier 112 is not included, against the insulating layer 110. The plate 430 may include a hole 434 through which the drive pin 420 may extend to drive the fastener 116 (a nail in this embodiment). Positioning the plate 430 and its flat outer side 432 against the insulation wall panel 100 may locate and stabilize the nail gun 400 and its barrel 410. As located and stabilized, the drive pin 420 may more reliably drive each fastener 116 (a nail in this embodiment) into the insulated wall panel 100, approximately perpendicular to the exterior surface of the insulated wall panel 100 against which the plate 430 is positioned.

As described above, one or more fasteners 116 that are nails may be embedded in the insulation wall panel 100 such that their heads 117 are positioned abutting the structural layer 114. Depending on the combined thickness of the weather barrier 112, insulating layer 110, and moisture barrier 113, the drive pin 420 may not be long enough to drive each fastener 116 far enough into the insulation wall panel 100 for the head 117 to reach the structural layer 114. Using a drive pin 420 long enough to drive the fastener 116 that far may not be feasible, such as a drive pin 420 that extends out of the nail gun 400 at least ¾ inch. Extending that far may be dangerous and/or lead to drive pin 420 instability. To compensate, the fastener 116 may be elongated and include a second head 118. The drive pin 420 may thus strike and drive the second head 118 of the fastener 116 a lesser distance into the insulating layer 110 to drive the first head, head 117, against the structural layer 114. As described above, the head 117 may thus seat against the structural layer 114, providing more durability to the insulation wall panel 100 and preventing moisture from passing through the structural layer 114 abutting the fastener 116.

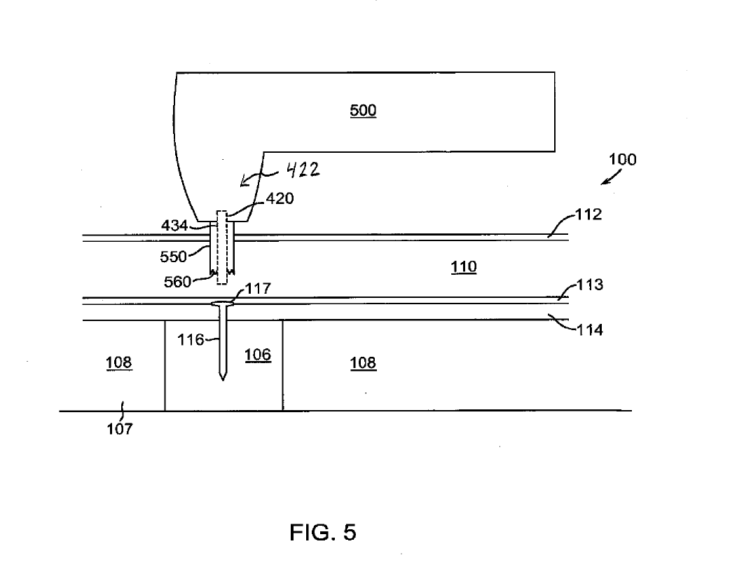

FIG. 5 illustrates a partial top view of an insulated wall panel along with another embodiment of a nail gun, nail gun 500. The nail gun 500 may be similar to the aforementioned nail gun 400 described above, but may include a toothed barrel 550 instead of the plate 430. The toothed barrel 550 may include a toothed end 560, and the toothed end 560 may be pressed into the insulated wall panel 100, puncturing and extending into the insulated wall panel 100, so that the drive pin 420 need not extend as far outside of the nail gun 500 as would the drive pin 420 of the nail gun 400 to drive the head 117 of the fastener 116 (a nail in this embodiment) into the insulated wall panel 100 and abutting the structural layer 114. The nail gun 500 may thus be able to, with more stability, drive a fastener 116 with only one head, head 117, into the insulated wall panel 100 such that the head 117 will be propelled to a position abutting the structural layer 114.

In another embodiment, the nail gun may include both the plate 430 of the nail gun 400 of FIG. 4 and the toothed barrel 550 of the nail gun 500 of FIG. 5. In this embodiment, the hole 434 of the plate 430 may be sized to allow the toothed barrel 550 to extend therethrough. The plate 430 or toothed barrel 550 may be spring-loaded or otherwise configured, as desired, such that the toothed barrel 550 may move relative to the plate 430. In another embodiment, the toothed barrel 550 may extend past the plate 430 such that the toothed barrel 550 can be pressed into the insulated wall panel 100 until the flat outer side 432 of the plate 430 is against the insulated wall panel 100. Then the fastener 116 may be propelled from the toothed barrel 550 to a position with its head abutting the structural layer 114.

The insulated wall panel 100 may be assembled in a method using the aforementioned nail guns in various embodiments. In one embodiment, a method of setting a fastener 116 that is a nail substantially through the insulating layer 110 and the moisture barrier 113 of the insulated wall panel 100 to attach the structural layer 114 (to which the moisture barrier 113, and thus the insulating layer 110, is attached) to a stud 106 uses the nail gun 500. In this method, the toothed end 560 of the toothed barrel 550 of the nail gun 500 is pressed into the insulating layer 110. As described above, pressing the toothed end 560 into the insulated wall panel 100 may puncture the insulated wall panel 100 such that the toothed end 560 will penetrate one or more layers. For example, the toothed end 560 may penetrate the insulating layer 110, thus first pressing through the weather barrier 112 (if included), when pressed into the insulating wall panel 100.

After the toothed end 560 of the toothed barrel 550 of the nail gun 500 is pressed into the insulating wall panel 100, a fastener 116 that is a nail may be propelled out of the toothed barrel 550 such that the head 117 of the fastener 116 is abutting the structural layer 114. Thus, the fastener 116 may be propelled from the toothed barrel 550 from within the insulating layer 110 and may travel through the moisture barrier 113 and into the structural layer 114, stopping when the head 117 of the fastener 116 contacts the structural layer 114. As described herein, the structural layer 114 may be a material stronger and denser than that of the insulating layer 110, and the head 117 may not be able to penetrate that material.

For example, the structural layer 114 may be oriented strand board while the insulating layer 110 may be EPS. The head 117 of the fastener 116 may be able to travel through the EPS when propelled out of the toothed barrel 550, but may be stopped by the oriented strand board, thus causing the fastener 116 to come to a rest with its head 117 positioned abutting the structural layer 114.

In one embodiment, the nail gun used in the method above may also include a plate. Thus, the nail gun may include both the plate 430 of the nail gun 400 of FIG. 4 and the toothed barrel 550 of the nail gun 500 of FIG. 5. Thus, in this method, the plate 430 may be placed against the insulated wall panel 100, such as against the weather barrier 112 (if included) or the insulating layer 110. Then, with the nail gun located and stabilized, the toothed barrel 550, which may move relative to the plate 430, may be pressed into the insulated wall panel 100 while the plate 430 remains positioned against the insulated wall panel 100. In another embodiment as described above, the toothed barrel 550 may extend past the plate 430 and thus the toothed barrel 550 may be pressed into the insulated wall panel 100 until the plate 430 encounters the weather barrier 112 (if included) or insulating layer 110. Then, the nail gun may be triggered to propel the fastener 116 out of the toothed barrel 550 such that the fastener 116 comes to a rest with its head 117 abutting the structural layer 114 of the insulated wall panel 100.

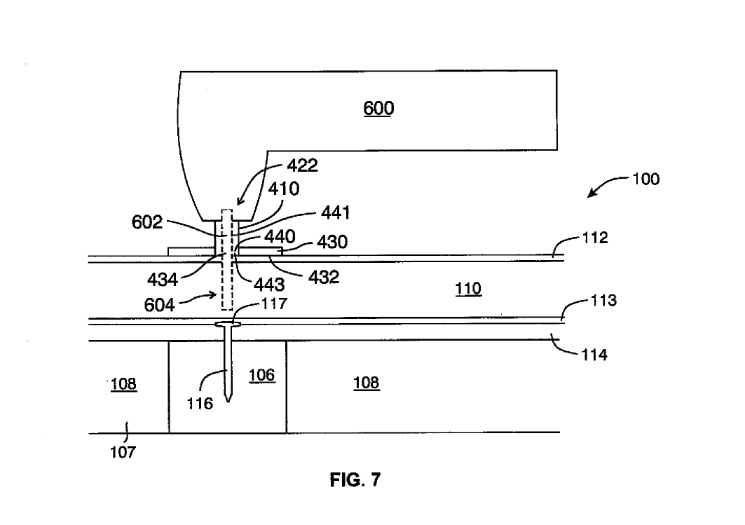

In another preferred embodiment shown in FIG. 7 there is illustrated a partial top plan view of an insulated wall panel along with another embodiment of a nail gun, nail gun 600. The nail gun 600 is similar to the above-described nail gun 400 and includes the plate 430 that defines a hole 434 through which the fastener 116 can pass. The nail gun 600 also has a barrel 440 that defines a barrel bore 441. The nail gun 600 further has an elongated drive pin 602 that is longer as compared to the previously described drive pin 420. The elongated drive pin 602 is driven by the drive assembly 422 and is movable between a retracted position wherein the elongated drive pin 602 is internal to the nail gun 600 to an extended position 604. The elongated drive pin 602 has a length such that when it is in the extended position 604 the elongated drive pin 602 extends beyond an end 443 of the barrel 440 one inch in one of the preferred embodiments, and in other preferred embodiments extends about one inch beyond the end 443 of the barrel 440.

In addition, although it is mentioned above that using a standard drive pin 420 and extending the drive pin far out beyond the barrel may be dangerous and/or lead to drive pin 420 instability, this potential problem has been found not to exist. Rather use of an elongated drive pin 602 has proven to be quite feasible in actual practice. When the nail gun 600 fires the elongated drive pin 602 it impacts the head 117 of the fastener 116 and drives the fastener 116 into the insulated wall panel 100 such that the head 117 abuts the structural layer 114.

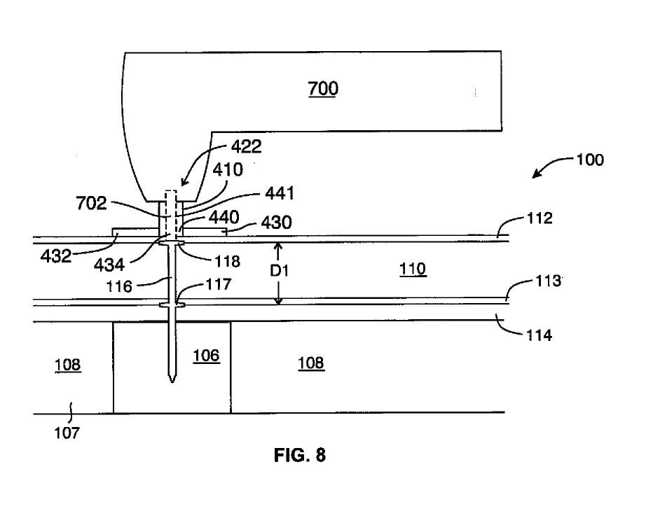

In another preferred embodiment shown in FIG. 8 there is illustrated a partial top plan view of an insulated wall panel along with another embodiment of a nail gun, nail gun 700. The nail gun 700 is similar to the above-described nail gun 400 and includes the plate 430 that defines a hole 434 through which the fastener 116 can pass. As shown, in this embodiment the fastener 116 has the head 117 and the second head 118, that is, it is double headed as shown. The distance from the head 117 to the second head 118 is indicated by D1 in the figure and is one inch in one of the preferred embodiments, and in another preferred embodiment is about one inch, and in another preferred embodiment is equals the thickness of the insulating layer 110. The nail gun 700 also has a barrel 440 that defines a barrel bore 441. The nail gun 700 further has a truncated drive pin 702 that is shorter as compared to the previously described drive pin 420. The truncated drive pin 702 has a length such that it does not extend beyond the end 443 of the barrel in one of the preferred embodiments. When installing fasteners, the truncated drive pin 702 impacts the second head 118 of the fastener 116 and drives the fastener 116 into the insulated wall panel 100, such that the head 117 abuts the structural layer 114. The second head 118 may be exposed, or substantially flush with the surrounding weather barrier 112, or the second head 118 may be recessed relative to the weather barrier 112, but still visible. Thus, the fastener 116 will be visible and this facilitates subsequent inspection of the insulated wall panel 110 when checking to make certain that fasteners 116 are in place.

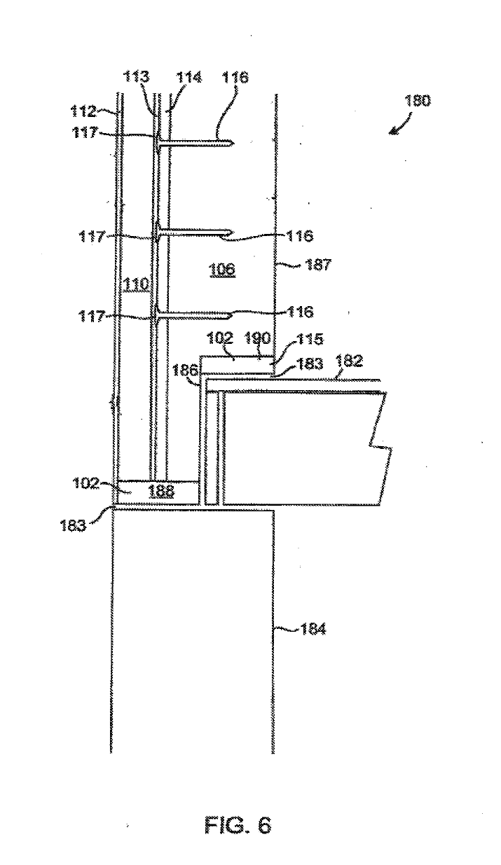

FIG. 6 illustrates a partial cut-away detail of an embodiment of an insulated wall panel 180 to floor structure 182 interconnection. In traditional construction, walls are normally set on floors and air infiltration and heat transfer can be problems at the connection area between the wall and the uninsulated, exposed portion of the floor structure. Accordingly, the embodiment illustrated in FIG. 6 has been designed to extend the insulating layer 110 along the floor structure 182 and provide a long joint 183 that can be filled to prevent or minimize air infiltration and heat transfer. For example, insulating material may be placed in the long joint 183 between the insulated wall panel 180 and the support structure 184 or floor structure 182 to minimize air infiltration or heat transfer in the area where the insulated wall panel 180 is supported. The support structure 184 may furthermore be any support structure 184 such as, for example, a foundation wall or a lower floor wall.

In the embodiment illustrated in FIG. 6, the floor structure 182 is set or constructed to partially rest on a support structure 184 such as a footer, foundation wall, or an insulated wall panel 100. The insulated wall panel 180 to be set on the floor structure 182 includes a notch 186 in its inner surface 187. The insulated wall panel 180 may furthermore be constructed having two base plates 102, a support structure base plate 188, and a floor base plate 190 or may be constructed with a single base plate 102 that sets on the floor structure 182. In an embodiment having two base plates 188 and 190, the support structure base plate 188 is placed on the support structure 184 and the floor base plate 190 is placed on the floor structure 182.

In various embodiments, an insulated wall panel system includes the insulated wall panel, such as the insulated wall panel 100 or 180 described herein, and a nail gun, such as, as described above, the nail gun 400, nail gun 500, the nail gun including both the plate 430 of the nail gun 400 and toothed barrel 550 of the nail gun 500, the nail gun 600, or the nail gun 700. In one such embodiment, the insulated wall panel is the insulated wall panel 100 including the insulating layer 110, moisture barrier 113 abutting the insulating layer 110, the structural layer 114 abutting the moisture barrier 113 such that the moisture barrier 113 is between the insulating layer 110 and the structural layer 114, a plurality of studs 106 abutting the structural layer 114, and a plurality of insulating panels 108 abutting the structural layer 114. Each of the plurality of insulating panels 108 may be positioned between two of the plurality of studs 106. Additionally, the insulated wall panel 100 may include a plurality of fasteners 116 that are nails. Each of the nails may include a head 117 embedded in the insulated wall panel 100 such that the head 117 is abutting the structural layer 114. The nail gun of the system may be for driving each nail through the insulating layer 110 and into the moisture barrier 113, the structural layer 114, and one of the studs 106 such that the head 117 of each of the plurality of nails is abutting the structural layer 114.

The insulated wall panel 100 or 180 of the system above may include one or more additional parts as described herein, such as the weather barrier 112, the base plate 102 and header plate 104 (for insulated wall panel 100) or base plates 188 and 190 and header plate (not shown) (for insulated wall panel 180), and or one or more other parts.

Embodiments of the insulated wall panels 100 and 180 as described herein can be used as exterior, above grade walls for commercial and residential buildings, for example. Insulated wall panels 100 and 180 can be manufactured in any size, such as, for example, the size of a side of a house.

In an embodiment, an insulated wall panel 100 is manufactured in an eight foot by fifty foot section. Holes are cut in the insulated wall panel 100 to create openings desired in a side of a house, such as the openings described below to accommodate windows and doors, for example. The insulated wall panel 100 is then set on a support structure, such as a footer, foundation wall, or another insulated wall panel 100. Additional insulated wall panels 100 and/or 180 are then set to form up to all of the exterior, above grade walls of the house. Adjacent insulated wall panels 100 and/or 180 are then attached to one another to form the perimeter of the house.

Such insulated wall panels 100 and/or 108 may be manufactured in a manufacturing facility, transported to a building site, and set in place using a crane or other machinery.

In one embodiment, the insulated wall panel consists of:

a weather barrier;

an insulating layer abutting the weather barrier;

a moisture barrier abutting the insulating layer;

a structural layer abutting the moisture barrier, the moisture barrier between the insulating layer and the structural layer;

a plurality of studs abutting the structural layer;

a second insulating layer comprising a plurality of insulating panels, each of the plurality of insulating panels positioned between two of the plurality of studs; and

a plurality of fasteners each comprising a first head and second head spaced at least 3/16 of an inch apart, each of the plurality of fasteners embedded in the insulated wall panel such that for each fastener, the fastener extends into the stud and the first head is in contact with and seated against the structural layer and the second head is embedded in the insulated wall panel.

In another embodiment, the insulated wall panel consists of:

a weather barrier;

an insulating layer abutting the weather barrier;

a moisture barrier abutting the insulating layer;

a structural layer abutting the moisture barrier, the moisture barrier between the insulating layer and the structural layer;

and a fastener including a first head and a second head, and wherein the first head is in contact with and seated against the structural layer and the second head is embedded in the insulated wall panel.

In another embodiment, the insulated wall panel includes:

a weather barrier;

an insulating layer abutting the weather barrier;

a moisture barrier abutting the insulating layer;

a structural layer abutting the moisture barrier, the moisture barrier between the insulating layer and the structural layer;

a plurality of studs abutting the structural layer;

a second insulating layer comprising a plurality of insulating panels, each of the plurality of insulating panels positioned between two of the plurality of studs; and

a plurality of fasteners each having a single head, each of the plurality of fasteners embedded in the insulated wall panel such that for each fastener the fastener extends into the stud and a head of the fastener is in contact with and seated against the structural layer.

In another embodiment, the insulated wall panel comprises:

a weather barrier;

an insulating layer abutting the weather barrier;

a moisture barrier abutting the insulating layer;

a structural layer abutting the moisture barrier, the moisture barrier between the insulating layer and the structural layer;

and a fastener having a head and wherein the head is in contact with and seated against the structural layer.

The above descriptions provide for methods for constructing insulated wall panels 100.

In other preferred embodiments there are methods for using the nail guns 600 and 700 for making insulated wall panels 100.

There is a method of providing an insulated wall panel comprising the acts of:

providing a nail gun having a barrel that has an end and defining a bore in the barrel;

providing a plate and defining a hole in the plate and positioning the barrel in the hole and joining the barrel and the plate;

providing an elongated drive pin and positioning the elongated drive pin in the barrel such that the elongated drive pin is movable from a retracted position internal to the barrel to an extended position wherein the elongated drive pin extends an inch beyond the end of the barrel;

providing an insulated wall panel by providing a weather barrier, abutting an insulating layer against the weather barrier, abutting a moisture barrier against the insulating layer, and abutting a structural layer against the moisture barrier such that the moisture barrier is between the insulating layer and the structural layer;

providing a fastener having a single head and driving the elongated drive pin into the single head such that the single head is in contact with and seated against the structural layer.

And, there is another method of providing an insulated wall panel comprising the acts of:

providing a nail gun having a barrel that has an end and defining a bore in the barrel;

providing a plate and defining a hole in the plate and positioning the barrel in the hole and joining the barrel and the plate;

providing a truncated drive pin and positioning the truncated drive pin in the barrel and the truncated drive pin is substantially flush with the barrel end at the maximum extension thereof;

providing an insulated wall panel by providing a weather barrier, abutting an insulating layer against the weather barrier, abutting a moisture barrier against the insulating layer, and abutting a structural layer against the moisture barrier such that the moisture barrier is between the insulating layer and the structural layer;

providing a fastener having a head and a second head and driving the truncated drive pin into the second head until the head is in contact with and seated against the structural layer.

While specific embodiments of the invention have been described in detail, it should be appreciated by those skilled in the art that various modifications and alternations could be developed in light of the overall teachings of the disclosure. Accordingly, the particular arrangements, apparatuses, systems, and methods disclosed are meant to be illustrative only and not limiting as to the scope of the invention.

What is claimed is:

1. A nail gun comprising:
a housing and a barrel that extends from the housing and the barrel has an end and the barrel defines a barrel bore;
a drive assembly;
a plate that defines a hole and wherein the barrel extends through the hole in the plate and is joined to the plate;
an elongated drive pin disposed in the barrel bore and the drive assembly for driving the elongated drive pin, and the drive assembly is capable of moving the elongated drive pin from retracted position wherein the elongated drive pin is disposed internal to the barrel to an extended position wherein at least a portion of the elongated drive pin extends beyond the end of the barrel; and,
wherein when the elongated drive pin is in the extended position it extends beyond the end of the barrel.

2. The nail gun according to claim 1 wherein the when the elongated drive pin is in the extended position it extends an inch beyond the end of the barrel.

3. The nail gun according to claim 1 wherein the when the elongated drive pin is in the extended position it extends about an inch beyond the end of the barrel.

4. A nail gun for driving a fastener having a head and a second head, the nail gun comprising:
a housing and a barrel that extends from the housing and the barrel has an end and the barrel defines a barrel bore;
a drive assembly;
a plate that defines a hole and the barrel extends through the hole in the plate and is joined to the plate;
a truncated drive pin disposed in the barrel bore and the drive assembly is for driving the truncated drive pin and the drive assembly is capable of moving the truncated drive pin in the barrel; and,
wherein when the nail gun truncated drive pin is moved in the barrel it is capable of driving the fastener by impacting the second head.

5. A method of making an insulated wall panel comprising the acts of:
providing a nail gun having a barrel that has an end and defining a bore in the barrel;
providing a plate and defining a hole in the plate and positioning the barrel in the hole and joining the barrel and the plate;
providing an elongated drive pin and positioning the elongated drive pin in the barrel such that the elongated drive pin is movable from a retracted position internal to the barrel to an extended position wherein the elongated drive pin extends an inch beyond the end of the barrel;
providing an insulated wall panel by providing a weather barrier, abutting an insulating layer against the weather barrier, abutting a moisture barrier against the insulating layer, and abutting a structural layer against the moisture barrier such that the moisture barrier is between the insulating layer and the structural layer;
providing a fastener having a single head and driving the elongated drive pin into the single head such that the single head is in contact with and seated against the structural layer.

6. The method of making an insulated wall panel according to claim 5 further including providing at least one stud abutting the structural layer and providing a second insulating layer abutting the structural layer.

7. The method of making an insulated wall panel according to claim 6 further including providing a plurality of studs and abutting the studs against the structural layer, and providing the second insulating layer with a plurality of insulation panels such that at least one of the plurality of studs extends between two of the plurality of insulation panels.

8. The method of making an insulated wall panel according to claim 7 further including providing the second insulating layer to be fiberglass batt having at least a R-13 total value.

9. The method of making an insulated wall panel according to claim 5 further including providing the weather barrier to be a polypropylene film.

10. The method of making an insulated wall panel according to claim 5 further including providing the insulating layer to be expanded polystyrene having at least a R-5 total value and providing the moisture barrier to include polyurethane.

11. The method of making an insulated wall panel according to claim 5 further including providing the structural layer to be oriented strand board.

12. A method of making an insulated wall panel comprising the acts of:
providing a nail gun having a barrel that has an end and defining a bore in the barrel;
providing a plate and defining a hole in the plate and positioning the barrel in the hole and joining the barrel and the plate;
providing a truncated drive pin and positioning the truncated drive pin in the barrel and the truncated drive pin is substantially flush with the barrel end at the maximum extension thereof;
providing an insulated wall panel by providing a weather barrier, abutting an insulating layer against the weather barrier, abutting a moisture barrier against the insulating layer, and abutting a structural layer against the moisture barrier such that the moisture barrier is between the insulating layer and the structural layer;
providing a fastener having a head and a second head and driving the truncated drive pin into the second head until the head is in contact with and seated against the structural layer.

13. The method of making an insulated wall panel according to claim 12 further wherein after driving the fastener the second head is flush with the weather barrier.

14. The method of making an insulated wall panel according to claim 12 further including providing at least one stud abutting the structural layer and providing a second insulating layer abutting the structural layer.

15. The method of making an insulated wall panel according to claim 14 further including providing a plurality of studs and abutting the studs against the structural layer, and providing the second insulating layer with a plurality of insulation panels such that at least one of the plurality of studs extends between two of the plurality of insulation panels.

16. The method of making an insulated wall panel according to claim 15 further including providing the second insulating layer to be fiberglass batt having at least a R-13 total value.

17. The method of making an insulated wall panel according to claim 12 further including providing the weather barrier to be a polypropylene film.

18. The method of making an insulated wall panel according to claim 12 further including providing the insulating layer to be expanded polystyrene having at least a R-5 total value and providing the moisture barrier to include polyurethane.

19. The method of making an insulated wall panel according to claim 12 further including providing the structural layer to be oriented strand board.
